(19) United States
(12) Patent Application Publication
(10) Pub. No.: US 2023/0405857 A1
(43) Pub. Date: Dec. 21, 2023

(54) RAZOR CARTRIDGE

(71) Applicant: DORCO CO., LTD., Seoul (KR)

(72) Inventor: Min Joo PARK, Seoul (KR)

(21) Appl. No.: 18/336,307

(22) Filed: Jun. 16, 2023

(30) Foreign Application Priority Data
Jun. 17, 2022 (KR) 10-2022-0074329
May 25, 2023 (KR) 10-2023-0067884

(51) Int. Cl. B26B 21/56; B26B 21/40

(52) U.S. Cl. CPC B26B 21/565; B26B 21/4031; B26B 21/60

(57) ABSTRACT

A razor cartridge is proposed. The razor cartridge may include at least one blade having a cutting edge. The blade may include a substrate including a substrate tip, and a coating layer formed on the substrate to form the cutting edge. The coating layer may include a first facet extending toward one side from a final tip forming a tip of the cutting edge, a second facet extending toward the other side from the final tip, a third facet extending from the first facet, and a fourth facet extending from the second facet. A distance between a second wedge formed at a boundary between the second facet and the fourth facet and a dividing line dividing the final tip may be longer or shorter with a deviation ±20% as compared to a distance between a first wedge formed at a boundary between the first facet and the third facet and the dividing line.

### CROSS REFERENCE TO RELATED APPLICATION

This application claims the benefit of Korean Patent Application Nos. 10-2022-0074329, filed on Jun. 17, 2022, and 10-2023-0067884, filed on May 25, 2023, the contents of which are all hereby incorporated by reference herein in their entirety.

### BACKGROUND

### Technical Field

The present disclosure relates to a razor cartridge, and more particularly, to a razor cartridge used in a disposable razor or a cartridge replaceable razor.

### Description of Related Technology

A razor is a product that cuts and removes body hair such as facial hair, facial hair, and beard. The razor is largely divided into a handle to be gripped by a user and at least one blade for cutting body hair according to movement of the handle associated with the user's movement. Such a blade is accommodated in a razor cartridge connected to the handle. The razor includes a disposable razor in which a razor cartridge is not replaceable, and a cartridge replaceable razor detachable from the handle.

### SUMMARY

An aspect of the present disclosure provides a razor cartridge that forms an asymmetrical blade so that coating layers formed on both sides of a substrate are different in thickness.

Another aspect of the present disclosure provides a razor cartridge that forms an asymmetrical blade by reducing or increasing a thickness of a coating layer on the other side of the substrate, compared to a thickness of a coating layer on one side facing skin surface.

In one aspect, there is provided a razor cartridge including at least one blade having a cutting edge; and a blade housing for accommodating the blade in a longitudinal direction so that at least a portion of the cutting edge is exposed upwardly. The blade includes: a substrate including a substrate tip, a first surface extending toward one side from the substrate tip, and a second surface extending toward the other side from the substrate tip; and a coating layer formed on the substrate to form the cutting edge and comprises a first facet extending toward one side from a final tip forming a tip of the cutting edge, a second facet extending toward the other side from the final tip, a third facet extending from the first facet, and a fourth facet extending from the second facet. The first facet and the third facet are configured to face skin during shaving, while the second facet and the fourth facet are configured to be spaced apart from the skin during shaving. A distance between a second wedge formed at a boundary between the second facet and the fourth facet and the dividing line is longer or shorter with a deviation ±20% as compared to a distance between a first wedge formed at a boundary between the first facet and the third facet and a dividing line dividing the final tip.

The distance between the second wedge formed at the boundary between the second facet and the fourth facet and the dividing line may be shorter with a deviation of −15% to −20% as compared to the distance between the first wedge formed at the boundary between the first facet and the third facet and the final tip.

The distance between the second wedge formed at the boundary between the second facet and the fourth facet and the dividing line may be longer with a deviation of +15% to +20% as compared to the distance between the first wedge formed at the boundary between the first facet and the third facet and the final tip.

The dividing line may be a straight line connecting the final tip and the substrate tip.

The dividing line may be a straight line that connects a first center point of the blade spaced 1 micrometer away from the final tip and a second center point of the blade spaced 5 micrometers away from the final tip.

The distance between the second wedge and the dividing line may be longer than the distance between the first wedge and the dividing line.

The distance between the second wedge and the dividing line may be shorter than the distance between the first wedge and the dividing line.

An angle between the dividing line and the first facet at the final tip may have a value between 30 degrees and 70 degrees.

An angle between the first facet and the third facet may have a value between 100 degrees and 170 degrees.

The distance between the first wedge and the dividing line has a value between 0.2 micrometer and 0.4 micrometer.

The distance between an intersection point of a wedge line connecting the first wedge and the second wedge and the dividing line and the final tip may have a value between 0.1 micrometer and 0.6 micrometer.

At least one of the first wedge and the second wedge may be formed closer to the final tip than to the substrate tip.

At least one of the first wedge and the second wedge may be formed closer to the final tip than to the substrate tip.

The first wedge may be formed closer to the final tip than the second wedge.

The second wedge may be formed closer to the final tip than the first wedge.

The first facet and the second facet may be formed asymmetrically with respect to the dividing line.

The substrate may be formed symmetrically with respect to the dividing line.

Details of other embodiments are included in the detailed description and drawings.

The effects of the razor cartridge according to the present disclosure are as follows.

Assuming that a wedge line connects the first wedge formed at the boundary between the first facet and the third facet and the second wedge formed at the boundary between the second facet and the fourth facet and that the dividing line passing through the final tip and is perpendicular to the wedge line, the cutting edge is formed asymmetrically so that the distance between the second wedge and the dividing line has a deviation of 20% when a distance between the first wedge facing the skin surface and the dividing line is constant. Accordingly, it is possible to reduce the cutting force, improve shaving sensation, and secure the durability of the blade.

### BRIEF DESCRIPTION OF THE DRAWINGS

FIG. 1 is a schematic side view of a razor.

FIG. 2 is a plan view of a razor cartridge according to an embodiment of the present disclosure shown in FIG. 1.

FIG. 3 is a cross-sectional view taken along line III-III shown in FIG. 2.

FIG. 4 is a view showing a configuration of a blade shown in FIG. 3.

FIG. 5 is an enlarged cross-sectional view of area A shown in FIG. 4.

FIG. 6 is a chart showing the optimum thickness for a substrate shown in FIG. 5;

FIG. 7 is an enlarged cross-sectional view of a first embodiment regarding a substrate and a cutting edge of a blade shown in FIG. 5.

FIG. 8 is an enlarged cross-sectional view of a second embodiment regarding a substrate and a cutting edge of a blade shown in FIG. 5.

### DETAILED DESCRIPTION

A blade is disposed transversely to a shaving direction of the razor cartridge to cut the body hair. A cutting force generally refers to a cutting resistance between the body hair and the blade during hair cutting. The smaller the cutting force is, the more efficiently the hair is cut and the more comfortable the user feels during shaving. The blade includes a substrate used as a base material, a metal coating layer laminated on the substrate, and a resin coating layer laminated on the metal coating layer.

Meanwhile, the cutting force of the blade and the shaving sensation provided to the user during shaving are based on the thickness and shape of the substrate. For example, if the thickness of the substrate of the blade is thinner, the cutting force of the blade is further reduced, thereby enabling efficient cutting of the body hair and providing the user with a comfortable shaving sensation. In addition, the cutting force of the blade changes based on the shape of the blade that constitutes one side facing the skin surface and the other side.

However, the aforementioned thickness and shape of the substrate of the blade significantly affect the cutting force and shaving sensation during shaving. For example, if the thickness of the substrate is reduced, it may reduce the cutting force and thus improve the shaving sensation. In addition, when the substrate has a symmetrical shape in which a distance between one side facing the skin surface and the other side opposite to the one side is equal all over the substrate, there is a limitation in improving the cutting force and durability of the blade due to the characteristics of one side facing the skin surface and the opposite side facing away from the skin.

Hereinafter, a razor cartridge according to an embodiment of the present disclosure will be described in detail with reference to the accompanying drawings.

Prior to description, it should be noted in advance that the razor cartridge according to an embodiment of the present disclosure may be inseparably coupled to or integrally formed with a handle of a disposable razor, and may be selectively coupled to a handle of a cartridge replaceable razor.

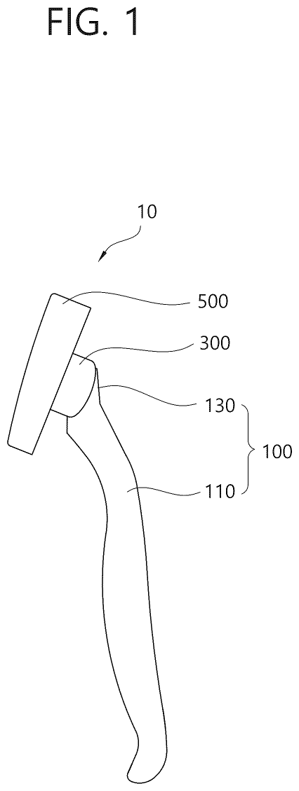

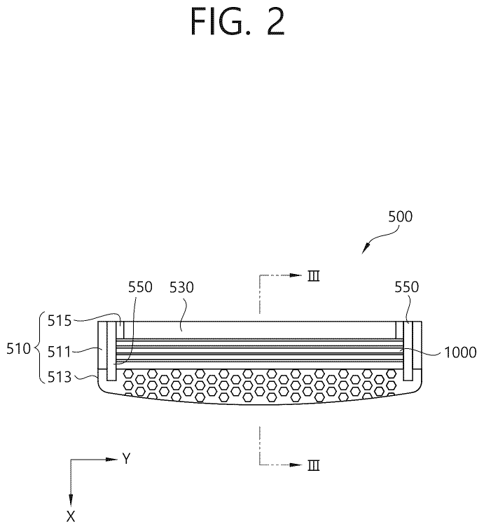

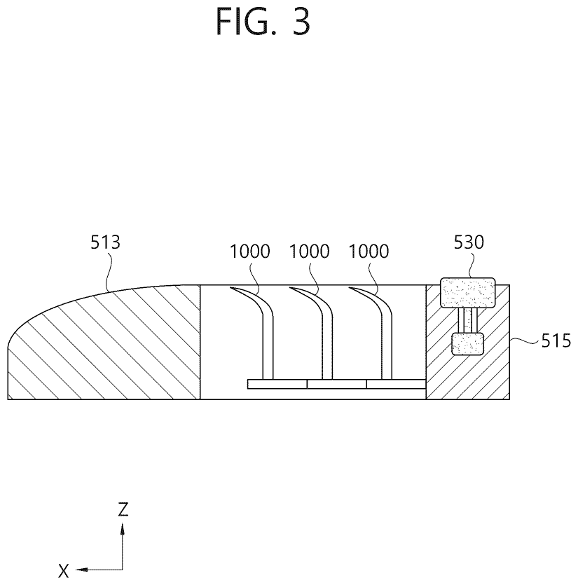

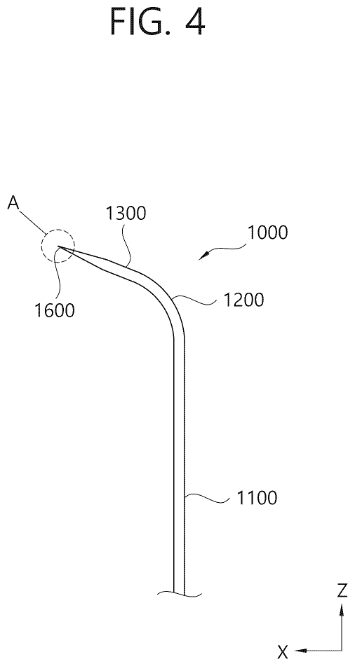

FIG. 1 is a schematic side view of a razor 10, FIG. 2 is a plan view of a razor cartridge 500 according to an embodiment of the present disclosure shown in FIG. 1, FIG. 3 is a cross-sectional view taken along line III-III shown in FIG. 2, and FIG. 4 is a view showing a configuration of a blade 1000 shown in FIG. 3.

As shown in FIGS. 1 to 4, the razor 10 includes a handle 100, a handle coupling part 300, and a razor cartridge 500 according to an embodiment of the present disclosure.

The handle 100 is gripped by a user. The handle 100 includes a handle body 110 and a handle header 130.

The handle body 110 is a part of razor 10 gripped by the user. The handle header 130 may be provided at one end of the handle body 110 and detachably coupled to the razor cartridge 500. Also, the handle body 110 pivotably supports the selectively coupled razor cartridge 500. Here, in the case of a disposable razor, the handle body 110 is inseparably coupled to or integrally formed with the razor cartridge 500.

The handle header 130 is coupled to the handle coupling part 300 formed under the razor cartridge 500. The handle header 130 is coupled to the handle coupling part 300 so as to pivotably support the razor cartridge 500 within a certain angle range for a fixed axis or an axis that moves within a certain range.

Also, the handle header 130 is selectively coupled to the handle coupling part 300 in the cartridge replaceable razor. In this case, the handle 100 may be provided with an operator (not shown) capable of operating the handle header 130. The user is able to release the coupling between the handle header 130 and the handle coupling part 300 by operating the operator.

The razor cartridge 500 according to an embodiment of the present disclosure includes a blade housing 510, a lubricating band 530, a clip 550, and a blade 1000.

The blade housing 510 includes a frame 511, a guard 513, and a cap 515. Here, the guard 513 is disposed in front (or in a positive X-axis direction of) the frame 511, and the cap 515 is disposed at rear (or in a negative X-axis direction) of the frame 511.

A central portion of the frame 511 is formed to be open upward. The frame 511 accommodates at least one blade 1000 in a longitudinal direction (Y-axis direction). When a plurality of blades 1000 is disposed at the frame 511, each blade 1000 may be arranged in a row in a transverse direction (X-axis direction) to the other blades 1000.

During shaving, the guard 513 comes into close contact with the user's skin surface to pull the skin surface, thereby improving the shaving effect of the blade 1000. An embossed or intaglio pattern may be formed in an upper surface of the guard 513 so as to more effectively pull the user's skin surface. The upper surface of the guard 513 may be formed of a material such as rubber and silicon. When the guard 513 includes a lubricating material, the guard 513 serves to pre-apply an auxiliary agent for shaving to the skin before the body hair touches the blade 1000.

The lubricating band 530 exposed through a top of the razor cartridge 500 may be disposed at the cap 515. The lubricating band 530 includes a lubricating material, and allows the lubricating material to be applied to the skin surface where the blade 1000 passes during shaving. The lubricating material may include components for protecting the skin surface after shaving.

The clip 550 surrounds both sides of the frame 511 and is coupled to the blade housing 510. The clip 550 prevents separation of the blade 1000 from the blade housing 510.

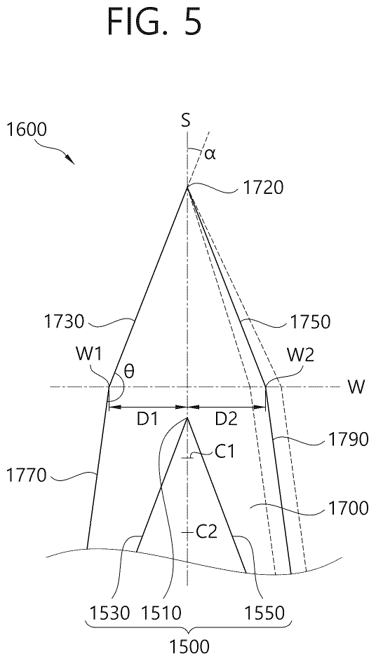

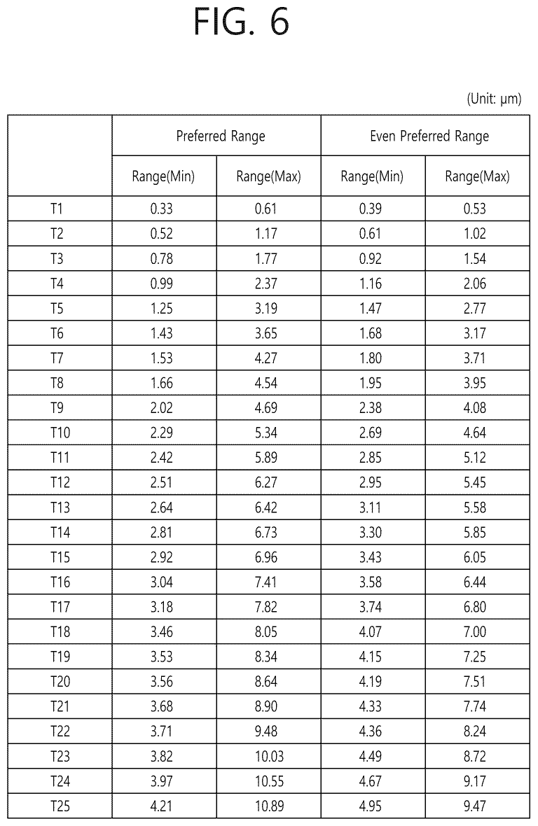

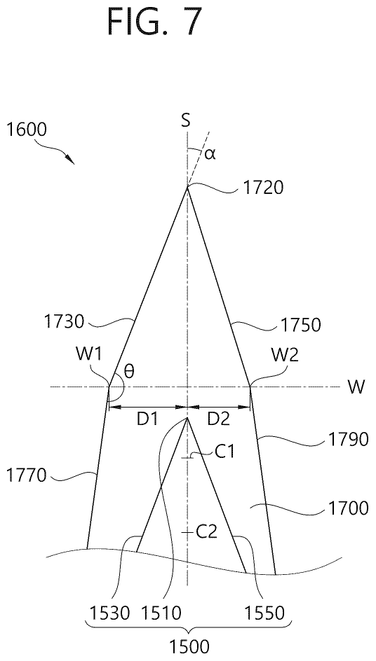

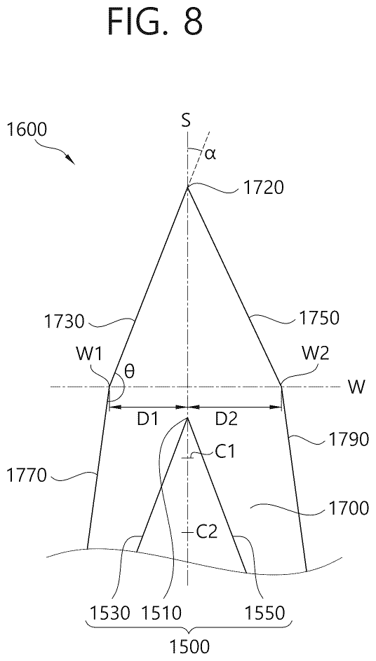

FIG. 5 is an enlarged cross-sectional view of area A shown in FIG. 4, FIG. 6 is a chart showing the optimal thickness for the substrate 1500 shown in FIG. 5, FIG. 7 is an enlarged cross-sectional view of a first embodiment regarding the substrate 1500 and the cutting edge 1600 of the blade 1000 shown in FIG. 5, and FIG. 8 is an enlarged cross-sectional view of a second embodiment regarding the substrate 1500 and the cutting edge 1600 of the blade 1000 shown in FIG. 5.

As shown in FIG. 4, the blade 1000 according to an embodiment of the present disclosure includes a base portion 1100, a bent portion 1200, and an edge portion 1300. The base portion 1100, the bent portion 1200, and the edge portion 1300 constitute parts of the blade 1000, respectively. The base portion 1100, the bent portion 1200, and the edge portion 1300 are integrally manufactured to form the blade 1000. In FIG. 4, the base portion 1100, the bent portion 1200, and the edge portion 1300 are shown as an integrated blade 1000, but aspects of the present disclosure are not limited thereto. Accordingly, in another embodiment, the blade 1000 may be a welded blade to which the edge portion 1300 is attached by welding, or may be a straight blade that does not include the bent portion 1200.

The base 1100 is supported by the blade housing 1510.

In one embodiment of the present disclosure, the bent portion 1200 is disposed between the base portion 1100 and the edge portion 1300 and connects the base portion 1100 and the edge portion 1300 to each other. The bent portion 1200 extends forward (in the positive X-axis direction) from the base portion 1100.

The edge portion 1300 extends along a bending direction of the bent portion 1200 bent from the base portion 1100. The edge portion 1300 is a region for substantially cutting body hair during shaving, and a cutting edge 1600 is formed at a tip of the edge portion 1300.

The blade 1000 includes a substrate 1500 and a coating layer 1700 stacked on the substrate 1500. The substrate 1500 forms the basic structure of the blade 1000 and is used as a base material for manufacturing the blade 1000. The substrate 1500 includes a substrate tip 1510, a first surface 1530 and a second surface 1550. The substrate tip 1510 is provided so that a final tip 1720 is formed when the coating layer 1700 is formed on the substrate 1500. The substrate 1500 is mainly formed of a metal material such as stainless steel, but silicon or ceramic may be used as well.

As shown in FIG. 6, numerical values for optimal thickness of the substrate 1500 are presented. At a time of manufacturing or using the blade 1000, the numerical values for thickness of T1 to T25 are important. Here, Tx indicates the thickness of the substrate 1500 in a region x micrometers away from the substrate tip 1510. For example, T1 indicates the thickness of the substrate 1500 in a region 1 micrometer away from the substrate tip 1510. The separation distance and thickness regarding T1 to T25 are expressed in micrometers.

The table of FIG. 6 shows values of T4, T16, T20, and T25 that affects physical properties among the thickness values of the substrate 1500 when the cutting edge 1600 of the blade 1000 is formed.

In one embodiment of the present disclosure, the substrate 1500 has a thickness T4 of 0.99 to 2.37 micrometers measured at a distance of 4 micrometers away from the substrate tip 1510, and the substrate 1500 has a thickness T16 of 3.04 to 7.41 micrometers measured at a distance of 16 micrometers away from the substrate tip 1510.

Further, the substrate 1500 has a thickness T20 of 3.56 to 8.64 micrometers measured at a distance of 20 micrometers away from the substrate tip 1510, and the substrate 1500 has a thickness of T25 of 4.21 to 10.89 micrometers measured at a distance of 25 micrometers away from the substrate tip 1510. Even in a case where the blade 1000 has an asymmetrical shape, a shape of the substrate 1500 serving as the base material of the blade 1000 has a significant impact on the overall shape, shaving performance, and durability of the blade 1000. In particular, a values of thickness in a region, such as T1 to T25, of the substrate 1500 relatively close to the substrate tip 1510 may play an important role in determining the characteristics of the blade 1000.

As shown in FIG. 5, the first surface 1530 and the second surface 1550 are formed to extend downward toward both sides of the substrate tip 1510 of the substrate. In one embodiment of the present disclosure, the first surface 1530 corresponds to one side that comes into contact with the skin surface during shaving, and the second surface 1550 corresponds to the other side opposite to the one side. The coating layer 1700 is formed on the first surface 1530 and the second surface 1550.

The cutting edge 1600 is formed in a tip region of the edge portion 1300 and is formed based on the formation of the substrate 1500 and the coating layer 1700 coated on the substrate 1500. The cutting edge 1600 performs a function of substantially cutting body hair during shaving. At least a portion of the cutting edge 1600 is exposed upward of the blade housing 1510 and comes into contact with body hair during shaving.

In one embodiment of the present disclosure, the coating layer 1700 includes a cutting edge 1600, a final tip 1720, a first facet 1730, a second facet 1750, a third facet 1770, and a fourth facet 1790. The coating layer 1700 has a basic structure consisting of hard coating and resin coating.

The coating layer 1700 of the blade 1000 includes a material based on CrC or Cr. Alternatively the coating layer 1700 may include a layer containing Carbon, a layer containing Boron, a layer containing Nitrogen, or a layer containing Oxide, or a material layer of a combination of at least some of these. Also, the texture of the coating layer 1700 may vary depending on whether the coating is a crystalline, amorphous, or nanocrystal layer.

The final tip 1720 forms the tip of cutting edge 1600. The final tip 1720 is spaced from the skin surface when shaving.

The first facet 1730 extends toward one side from the final tip 1720 forming the tip of the cutting edge 1600. The second facet 1750 extends toward the other side from the final tip 1720 and is formed to oppose the first facet 1730. The third facet 1770 extends from the first facet 1730. The fourth facet 1790 extends from the second facet 1750. The first facet 1730, second facet 1750, third facet 1770, and fourth facet 1790 of the present disclosure are formed in a straight line. However, aspects of the present disclosure are not limited thereto, and the first facet 1730, second facet 1750, third facet 1770, and fourth facet 1790 may have a convex or concave shape. In detail, the first facet 1730 and the third facet 1770 are configured to face the skin surface during shaving, and the second facet 1750 and the fourth facet 1790 are configured to be spaced apart from the skin surface during shaving. In one embodiment of the present disclosure, the first facet 1730 and the third facet 1770 face the skin surface. However, aspects of the present disclosure are not limited thereto, and the second facet 1750 may face the skin surface.

Meanwhile, a first wedge W1 is formed at the boundary between the first facet 1730 and the third facet 1770, and a second wedge W2 is formed at the boundary between the second facet 1750 and the fourth facet 1790. Here, the first wedge W1 corresponds to an intersection point of a virtual extension line of the first facet 1730 and a virtual extension line of the third facet 1770, and the second wedge W2 corresponds to an intersection point of a virtual extension line of the second facet 1750 and a virtual extension line of fourth facet 1790.

The blade 1000 according to an embodiment of the present disclosure takes the shape of an asymmetrical cutting edge 1600. As shown in FIG. 5, a dividing line S divides the final tip 1720. Specifically, when a virtual line connecting the first wedge W1 and the second wedge W2 is referred to as the wedge line W, the dividing line S corresponds to a virtual line passes through the final tip 1720 and is perpendicular to the wedge line W.

In order to form the asymmetric shape of the blade 1000 according to an embodiment of the present disclosure, a distance D2 between the second wedge W2 and the dividing line S may be 15% to 20% shorter or 15% to 20% longer than a distance D1 between the first wedge W1 and the dividing line S.

In detail, the first facet 1730 and the third facet 1770, forming the first wedge W1, correspond to a region facing or coming into contact with the skin surface during shaving, and the second facet 1750 and the fourth facet 1790, forming the second wedge W2, correspond to a region spaced apart from the skin surface and opposite to the first facet 1730 and the third facet 1770. The distance D1 between the first wedge W1 and the dividing line S is formed in predetermined thickness. The distance D2 between the second wedge W2 and the dividing line S has a deviation of ±20% as compared to the distance D1 between the first wedge W1 of the predetermined thickness and the dividing line S. The distance D2 between the second wedge W2 and the dividing line S may be −15% to −20% shorter or +15% to +20% longer than the distance D1 between the first wedge W1 of the predetermined thickness and the dividing line S.

FIG. 5 shows a blade 1000 in which the distance D2 between the second wedge W2 and the dividing line S in the shape of the symmetrical cutting edge 1600 has a thinner or thicker coating with a deviation of −20% to +20% as compared to the distance D1 between the wedge W1 and the dividing line S. On the other hand, FIG. 7 shows a blade in which the distance D2 between the second wedge W2 and the dividing line S shown in FIG. 5 is −15% to −20% shorter than the distance D1 between the first wedge W1 and the dividing line S, and FIG. 8 shows a blade 1000 in which the distance D2 between the second wedge W2 and the dividing line S shown in FIG. 5 is +15% to +20% longer than the distance D1 between the first wedge W1 and the dividing line S. That is, the distance D2 between the second wedge W2 and the dividing line S is longer or shorter than the distance D1 between the first wedge W1 and the dividing line S.

As shown in FIGS. 5, 7, and 8, in more detail, it means that the thickness of a coating layer 1700 forming the second facet 1750 and the fourth facet 1790 from the second surface 1550 is thicker or thinner with a deviation of ±20% as compared to the thickness of a coating layer 1700 forming the first facet 1730 and the third facet 1770 from the first surface 1530, Therefore, the distance D2 between the second wedge W2 and the dividing line S and the distance D1 between the first wedge W1 and the dividing line S cannot have the same distance. Accordingly, as compared to the thickness of the coating layer 1700 forming the second facet 1750 and the fourth facet 1790 form the second facet 1550, the thickness of the coating layer 1700 forming the first facet 1730 and the third facet 1770 from the first surface 1530 is different.

As described above, since the distance D2 between the second wedge W2 and the dividing line S is not equal to the distance D1 between the first wedge W1 and the dividing line S, an asymmetric coating layer 1700 is formed on the substrate 1500. At a time of forming the asymmetric coating layer 1700, the positions of the first wedge W1 and the second wedge W2 change between the substrate tip 1510 and the final tip 1720. For example, at a time of forming the asymmetric coating layer 1700, the first wedge W1 and the second wedge W2 may be closer to the substrate tip 1510 or closer to the final tip 1720. Also, the first wedge W1 may be located closer to or farther from the final tip 1720 than the second wedge W2.

In one embodiment of the present disclosure, an asymmetrical coating layer 1700 is formed when the distance D1 between the first wedge W1 and the dividing line S is fixed as a reference and the distance D2 between the second wedge W2 and the dividing line S is longer or shorter with a ±20% deviation than the distance D1 between the first wedge W1 and the dividing line S. In detail, the first facet 1730 and the third facet 1770 forming the first wedge W1 are the region that faces or comes into contact with the skin during shaving, and this region have a constant thickness in the present disclosure.

As shown in FIG. 7, the distance D2 between the second wedge W2 and the dividing line S may be formed to be shorter than the distance D1 between the first wedge W1 and the dividing line S so as to reduce the thickness of the coating layer 1700 formed on the second surface 1550, compared to the coating layer 1700 formed on the first surface 1530. In this case, as shown in FIG. 7, the thickness of the coating layer 1700 on the right side of the dividing line S is relatively thin compared to the thickness of the coating layer 1700 on the left side of the dividing line S, thereby providing a comfortable shaving feeling with an enhanced cutting force.

For example, referring to FIG. 7, when the tip of the substrate is sufficiently thick, there may be no difference in durability compared to the blade 100 having a thicker coating layer 1700 on the right side as shown in FIG. 8. If the coating layer 1700 on the right is relatively less than the coating layer 1700 on the left, it means that an angle of the final tip 1720 is relatively reduced. Accordingly, since initial tugging during shaving can be reduced due to the effective initial cut-in of the blade 1000, it is possible to provide a comfortable shaving feeling by reducing stinging on the user's skin. In addition, with the relatively thick coating layer 1700 on the left side, it is possible to prevent a situation in which the final tip 1720 directly contacts the skin surface during shaving, thereby minimizing irritation to the user's skin.

On the other hand, as shown in FIG. 8, the distance D2 between the second wedge W2 and the dividing line S may be formed to be longer than the distance D1 between the first wedge W1 and the dividing line S so as to increase the thickness of the coating layer 1700 formed on the second surface 1550, compared to the coating layer 1700 formed on the first surface 1530. In this case, when the thickness of the coating layer 1700 on the right side of the dividing line S is relatively thicker than the thickness of the coating layer 1700 on the left side of the dividing line S, durability and the cutting force are enhanced.

For example, referring to FIG. 8, more load is applied to the right side of the blade 1000 than the left side of the blade 1000 during shaving, and thus, If the coating layer 1700 on the right side is thicker, it enhances the blade 1000 relatively and may increases the durability of the blade 1000 particularly when the substrate tip 1510 is thin. And, when the blade 1000 on the right side is thick, the first wedge W1 and the second wedge W2 formed above the cutting edge 1600, which initial cut-in the hair, serve to widen a space between the body hair, thereby reducing cutting resistance to the body hair and thus improving a shaving sensation.

In one embodiment of the present disclosure, the dividing line S is a straight line connecting the final tip 1720 and the substrate tip 1510. In addition, the dividing line S may be a line that connects a first center point C1 of the blade 1000 spaced 1 micrometer away from the final tip 1720 and a second center point C2 of the blade 1000 spaced 5 micrometers away from the final tip 1720.

An angle α between the dividing line S and the first facet 1730 has a value between 30 degrees and 70 degrees at the final tip 1720. Further, the distance D1 between the first wedge W1 and the dividing line S may have a value between 0.2 micrometer and 0.4 micrometer. The distance D2 between the second wedge W2 and the dividing line S may be longer or shorter with a deviation of ±20%, compared to the distance D1 of 0.2 micrometer to 0.4 micrometer between the first wedge W1 and the dividing line S. For example, the distance D2 between the second wedge W2 and the dividing line S may have a value of 0.24 micrometer to 0.48 micrometer and longer than the distance D1 between the first wedge W1 and the dividing line S, or may have a value of 0.16 micrometer to 0.32 micrometer and longer than the distance D1 between the first wedge W1 and the dividing line S.

When the distance D2 between the second wedge W2 and the dividing line S is shorter with a deviation of −15% to −20% compared to the distance D1 of 0.2 micrometers to 0.4 micrometers between the first wedge W1 and the dividing line S, the distance D2 may be 0.16 micrometers to 0.34 micrometers. On the other hand, when the distance D2 between the second wedge W2 and the dividing line S is longer with a deviation of +15% to +20% compared to the first distance D1 of 0.2 micrometers to 0.4 micrometers between the first wedge W1 and the dividing line S, the distance D2 may be 0.23 micrometers to 0.48 micrometers.

An internal angle θ between the first facet 1730 and the third facet 1770 may have a value between 100 degrees and 170 degrees. At least one of the first wedge W1 and the second wedge W2 is formed closer to the final tip 1720 than the substrate tip 1510. On the other hand, at least one of the first wedge W1 and the second wedge W2 is formed farther from the final tip 1720 than the substrate tip 1510. Also, the first wedge W1 is formed closer to the final tip 1720 than the second wedge W2, or conversely, the second wedge W2 is formed closer to the final tip 1720 than the first wedge W1.

The base 1100 of the blade 1000 according to an embodiment of the present disclosure is formed symmetrically with respect to the dividing line S, but the region of the cutting edge 1600 is formed asymmetrically. The region of the cutting edge 1600 is formed asymmetrically by the conditions described above. In particular, the first facet 1730 and the second facet 1750 are formed asymmetrically with respect to the dividing line S.

The asymmetric shape of the region of the cutting edge 1600 of the blade 1000 according to an embodiment of the present disclosure may be defined by various conditions and numerical values. Typically, the asymmetric shape of the cutting edge 1600 may be defined by the distance between the first wedge W1 and the dividing line S and the distance D2 between the second wedge W2 and the dividing line S. Specifically, the distance D2 between the second wedge W2 and the dividing line S may be formed longer or shorter with a deviation of ±20% as compared to the distance D1 between the first wedge W1 and the dividing line S, and in doing so, the thickness of the coating layer 1700 formed on the second surface 1550 may be formed thicker or thinner than the thickness of the coating layer 1700 formed on the first surface 1530. As a result, the cutting edge 1600 of the blade 1000 may have an asymmetrical shape suitable for shaving.

Therefore, assuming that a wedge line W connects the first wedge W1 formed at the boundary between the first facet 1730 and the third facet 1750 and the second wedge W2 formed at the boundary between the second facet 1750 and the fourth facet 1790 and that the dividing line S passing through the final tip 1720 and is perpendicular to the wedge line W, the cutting edge 1600 is formed asymmetrically so that the distance D1 between the second wedge W2 and the dividing line S has a deviation of 20% when a distance between the first wedge W1 facing the skin surface and the dividing line S is constant. Accordingly, it is possible to reduce the cutting force, improve shaving sensation, and secure the durability of the blade 1000.

While embodiments of the present disclosure have been described with reference to the accompanying drawings, it will be understood by those of ordinary skill in the art that specific implementations may be varied and modified without departing from the scope of the present disclosure. Accordingly, it should be understood that the embodiments described above are merely examples for purposes of description and do not limit the present disclosure in any respect. Therefore, the scope of the present disclosure is limited solely by the following claims and their equivalents. Accordingly, the scope of the present disclosure is defined by the appended claims rather than the foregoing description and the exemplary embodiments described therein. Various modifications made within the meaning of an equivalent of the claims of the invention and within the claims are to be regarded to be in the scope of the present disclosure.

What is claimed is:

1. A razor cartridge comprising:
at least one blade comprising a cutting edge; and
a blade housing configured to accommodate the blade in a longitudinal direction so that at least a portion of the cutting edge is exposed upwardly,
wherein the blade comprises:
a substrate comprising a substrate tip, a first surface extending toward one side from the substrate tip, and a second surface extending toward the other side from the substrate tip; and
a coating layer formed on the substrate and configured to form the cutting edge, the coating layer comprising:
a first facet extending toward one side from a final tip forming a tip of the cutting edge;
a second facet extending toward the other side from the final tip;
a third facet extending from the first facet; and
a fourth facet extending from the second facet,
wherein the first facet and the third facet are configured to face skin during shaving, and the second facet and the fourth facet are configured to be spaced apart from the skin during shaving, and
wherein a distance between a second wedge formed at a boundary between the second facet and the fourth facet and a dividing line dividing the final tip is longer or shorter with a deviation of ±20% as compared to a distance between a first wedge formed at a boundary between the first facet and the third facet and the dividing line.

2. The razor cartridge of claim 1, wherein the distance between the second wedge and the dividing line is shorter with a deviation of −15% to −20% as compared to the distance between the first wedge and the dividing line dividing the final tip.

3. The razor cartridge of claim 1, wherein the distance between the second wedge and the dividing line is longer with a deviation of +15% to +20% as compared to the distance between the first wedge and the dividing line dividing the final tip.

4. The razor cartridge of claim 1, wherein the dividing line is a straight line connecting the final tip and the substrate tip.

5. The razor cartridge of claim 4, wherein the dividing line is a straight line that connects a first center point of the blade spaced 1 micrometer away from the final tip and a second center point of the blade spaced 5 micrometers away from the final tip.

6. The razor cartridge of claim 1, wherein the distance between the second wedge and the dividing line is longer than the distance between the first wedge and the dividing line.

7. The razor cartridge of claim 1, wherein the distance between the second wedge and the dividing line is shorter than the distance between the first wedge and the dividing line.

8. The razor cartridge of claim 1, wherein an angle between the dividing line and the first facet at the final tip is in a range of 30 degrees to 70 degrees.

9. The razor cartridge of claim 1, wherein an angle between the first facet and the third facet is in a range of 100 degrees to 170 degrees.

10. The razor cartridge of claim 1, wherein the distance between the first wedge and the dividing line is in a range of 0.2 micrometers to 0.4 micrometers.

11. The razor cartridge of claim 1, wherein a distance between an intersection point of a wedge line connecting the first wedge and the second wedge and the dividing line and the final tip is in a range of 0.1 micrometer to 0.6 micrometer.

12. The razor cartridge of claim 1, wherein at least one of the first wedge or the second wedge is formed closer to the final tip than to the substrate tip.

13. The razor cartridge of claim 1, wherein at least one of the first wedge or the second wedge is formed farther from the final tip than the substrate tip.

14. The razor cartridge of claim 1, wherein the first wedge is formed closer to the final tip than the second wedge.

15. The razor cartridge of claim 1, wherein the second wedge is formed closer to the final tip than the first wedge.

16. The razor cartridge of claim 1, wherein the first facet and the second facet are formed asymmetrically with respect to the dividing line.

17. The razor cartridge of claim 16, wherein the substrate is formed symmetrically with respect to the dividing line.
